(19) United States
(12) Patent Application Publication
(10) Pub. No.: US 2022/0134669 A1
(43) Pub. Date: May 5, 2022

(54) CALIBRATING SENSORS

(71) Applicant: Hewlett-Packard Development Company, L.P., Spring, TX (US)

(72) Inventors: Marc Garcia Grau, Sant Cugat del Valles (ES); Jorge Diosdado Borrego, Sant Cugat del Valles (ES); Marta Gonzalez Mallo, Sant Cugat del Valles (ES)

(73) Assignee: Hewlett-Packard Development Company, L.P., Spring, TX (US)

(21) Appl. No.: 17/416,750

(22) PCT Filed: Jul. 22, 2019
(86) PCT No.: PCT/US2019/042778

§ 371 Date: Jun. 21, 2021

(51) Int. Cl. B29C 64/386; B33Y 30/00; B33Y 50/00; B29C 64/295; B28B 1/00; B22F 10/80; B22F 12/90; B22F 12/17

(52) U.S. Cl. CPC B29C 64/386; B33Y 30/00; B33Y 50/00; B22F 12/17; B28B 1/001; B22F 10/80; B22F 12/90; B29C 64/295

(57) ABSTRACT

A sensor calibration method is disclosed. The method includes applying thermal energy to a fabrication chamber of an additive manufacturing apparatus to raise a temperature of a surface within the fabrication chamber to a first surface temperature; measuring, using a first sensor to be calibrated, the first surface temperature; measuring, using a second sensor, the first surface temperature; applying thermal energy to the fabrication chamber to raise a temperature of the surface to a second surface temperature; measuring, using the first sensor, the second surface temperature; measuring, using the second sensor, the second surface temperature; determining, using a processor, based on the first and second surface temperatures measured using the first sensor and on the first and second surface temperatures measured using the second sensor, an offset calibration to be applied to measurements obtained using the first sensor; and applying the offset calibration to measurements obtained using the first sensor. An additive manufacturing apparatus and a machine-readable medium are also disclosed.

### BACKGROUND

Additive manufacturing systems may be used to generate three-dimensional objects on a layer-by-layer basis by causing portions of build material to selectively coalesce.

An additive manufacturing apparatus may use a thermal sensor to measure a temperature of a component of the apparatus, and the thermal sensor may be calibrated in order to improve the accuracy of its readings.

### BRIEF DESCRIPTION OF DRAWINGS

Examples will now be described, by way of non-limiting example, with reference to the accompanying drawings, in which:

FIG. 1 is a schematic illustration of an example of an apparatus;

FIG. 2 is a flowchart of an example of a sensor calibration method;

FIG. 3 is a flowchart of a further example of a sensor calibration method;

FIG. 4 is a schematic illustration of an example of an additive manufacturing apparatus;

FIG. 5 is a flowchart of a further example of a sensor calibration method; and

FIG. 6 is a schematic illustration of a machine-readable medium in communication with a processor.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern.

According to one example, a suitable fusing agent may be an ink-type formulation comprising carbon black, such as, for example, the fusing agent formulation commercially known as V1Q60A “HP fusing agent” available from HP Inc. In one example such a fusing agent may additionally comprise an infra-red light absorber. In one example such a fusing agent may additionally comprise a near infra-red light absorber. In one example such a fusing agent may additionally comprise a visible light absorber. In one example such a fusing agent may additionally comprise a UV light absorber. Examples of print agents comprising visible light enhancers are dye based colored ink and pigment based colored ink, such as inks commercially known as CE039A and CE042A available from HP Inc.

In other examples, coalescence may be achieved in some other manner.

In addition to a fusing agent, in some examples, a print agent may comprise a coalescence modifying agent (referred to as modifying or detailing agents herein after), which acts to modify the effects of a fusing agent for example by reducing or increasing coalescence or to assist in producing a particular finish or appearance to an object, and such agents may therefore be termed detailing agents. A detailing agent (also termed a “coalescence modifier agent” or “coalescing modifier agent”) may, in some examples, have a cooling effect. In some examples, the detailing agent may be used near edge surfaces of an object being printed. According to one example, a suitable detailing agent may be a formulation commercially known as V1Q61A “HP detailing agent” available from HP Inc. A coloring agent, for example comprising a dye or colorant, may in some examples be used as a fusing agent or a modifying agent, and/or as a print agent to provide a particular color for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

An example additive manufacturing apparatus may include a print bed, or build platform, onto which a layer of build material may be formed. The additive manufacturing apparatus may also include a build material distributor to distribute or form build material on the print bed. In some examples, the additive manufacturing apparatus may include at least one source of radiation to direct radiation towards the print bed. The source of radiation may comprise at least one heat lamp, such as an infrared lamp, which may be positioned above the print bed such that radiation is directed downwards towards the print bed. The source of radiation may, in some examples, include at least one pre-heating lamp for pre-heating the build material and/or at least one fusing lamp for applying heat to fuse portions of the build material. The additive manufacturing apparatus may also include an agent distributor to distribute agent, such as fusing agent and/or detailing agent, onto the layer of build material formed on the print bed. The agent distributor may include at least one set of nozzles through which the print agent may be distributed onto the build material, each set of nozzles having at least one individual nozzle. The nozzles and/or the sets of nozzles may form part of a print head which, in some examples, may be a thermal print head or a piezo print head. The agent distributor may be movable relative to the print bed such that print agent may be selectively deposited, for example drop-by-drop, onto a portion of the layer of build material in a pattern derived from data representing a slice of the three-dimensional object to be built.

The agent distributor may be movable at least in a plane parallel to the print bed between a rest configuration, in which the agent distributor can be considered inactive or idle, and an active configuration, in which the agent distributor can distribute the print agent in accordance with the pattern.

The build platform, or print bed, may, in some examples, be positioned within, or form part of, a fabrication chamber (also referred to as a build chamber), in which a three-dimensional object may be built using the additive manufacturing techniques discussed herein.

The additive manufacturing apparatus, or a component thereof, may include a component to apply thermal energy (e.g. heat) to a part, or parts, of the additive manufacturing apparatus, in addition to the heat lamps mentioned above. In one example, thermal energy may be applied using a thermal blanket that is in thermal communication with, and/or that forms a part of, walls of the fabrication chamber and/or the print bed. During use, thermal energy may be applied to a component in order to raise the temperature of that component, for example to an operating temperature suitable for the additive manufacturing process.

The additive manufacturing apparatus may include a thermal sensor, such as a thermal imaging camera, that is positioned such that a temperature or temperatures of the print bed can be measured. The thermal sensor may, in some examples, also be used to measure temperatures of layers of build material as they are being processed on the print bed. However, various factors may affect the accuracy of such measurements. Such factors may include, for example, the emissivity of the material of the component whose temperature is being measured, differences in the temperature of air throughout the fabrication chamber (which may not be evident just from measurements of the temperature of the air adjacent to the thermal sensor), and manufacturing tolerances of the thermal sensor itself. Other sensors may be provided to measure temperatures of, or near to, particular components of the additive manufacturing apparatus. For example, a sensor may be provided to measure a temperature of the print bed. The sensor may be located in or close to the print bed itself, so that the measurements it takes are not affected by the same factors that affect the measurements acquired by the thermal sensor discussed above. In some examples, multiple sensors may be provided to measure temperatures of the print bed. For example, a plurality of sensors may measure temperatures at various locations on the print bed.

Due to the various factors mentioned above, the temperature measurements acquired by the thermal sensor and the sensor or sensors in the print bed may differ from one another. According to various examples of the present disclosure, measurements acquired by the thermal sensor and the sensors in the print bed may be used to determine a temperature offset relating measurement acquired by the thermal sensor to measurements acquired by the sensors in or at the print bed. The determined temperature offset may then be used to calibrate measurements acquired using the thermal sensor, as described herein.

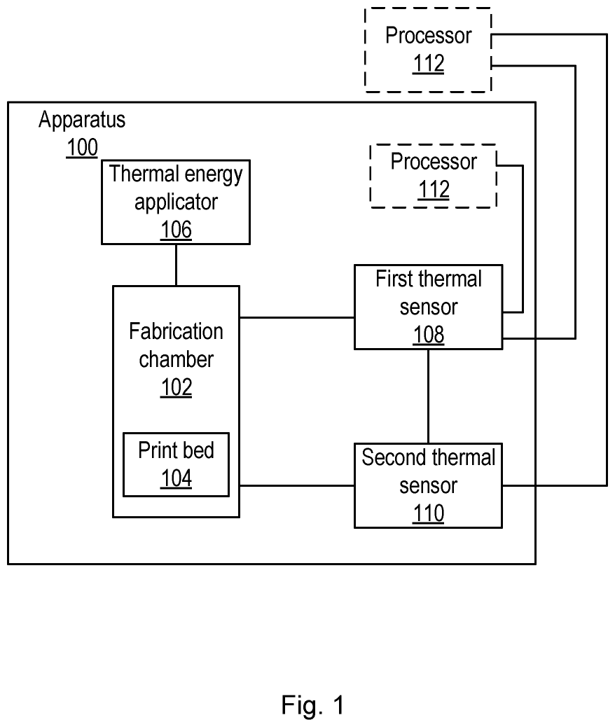

Referring to the drawings, FIG. 1 is a schematic illustration of apparatus 100 which may, for example, comprise an additive manufacturing apparatus. The apparatus 100 comprises a fabrication chamber 102 to house a print bed 104 on which a three-dimensional object may be formed by processing successive layers of build material. The fabrication chamber 102 may be considered to include walls, a top (e.g. a roof) and a bottom, defined by the print bed 104. In some examples, the print bed may move (e.g. up and down) relative to the walls of the fabrication chamber. The apparatus also comprises a thermal energy applicator 106 to apply thermal energy to the fabrication chamber 102 the successively heat up the print bed to at least two different target temperatures. For example, the thermal energy applicator 106 may first apply thermal energy to the fabrication chamber 102 (e.g. to walls of the fabrication chamber and/or to the print bed 104) until the print bed 104 reaches a first target temperature and, subsequently, the thermal energy applicator may apply thermal energy to the fabrication chamber until the print bed reaches a second target temperature. The apparatus 100 further comprises a first sensor 108, or thermal sensor, which is to be calibrated, and a second sensor, or thermal sensor, 110. The first thermal sensor 108 and the second thermal sensor 110 are to measure the target temperatures of the print bed 104. In some examples, due to differences in temperatures through the print bed, the thermal sensors 108, 110 may measure the target temperatures of a surface of the print bed 104. The apparatus 100 may further comprise a processor 112. In some examples, the processor 112 may form part of the apparatus 100 while, in other examples, the processor 112 may be remote from the apparatus, but may be in communication with the apparatus, or components thereof, such that measurements acquired by the first and second thermal sensors 108, 110 can be transmitted to and processed by the processor. In FIG. 1, the processor 110 is shown in dashed lines to indicate that it could form part of the apparatus 100 or could be located remote therefrom. The processor 112 is to determine, based on the target temperatures measured by the first and second thermal sensors 108, 110, a correction (e.g. a temperature offset) to be applied to measurements acquired using the first thermal sensor 108. The processor 112 is also to apply the determined correction or offset to subsequent measurements acquired using the first thermal sensor 108.

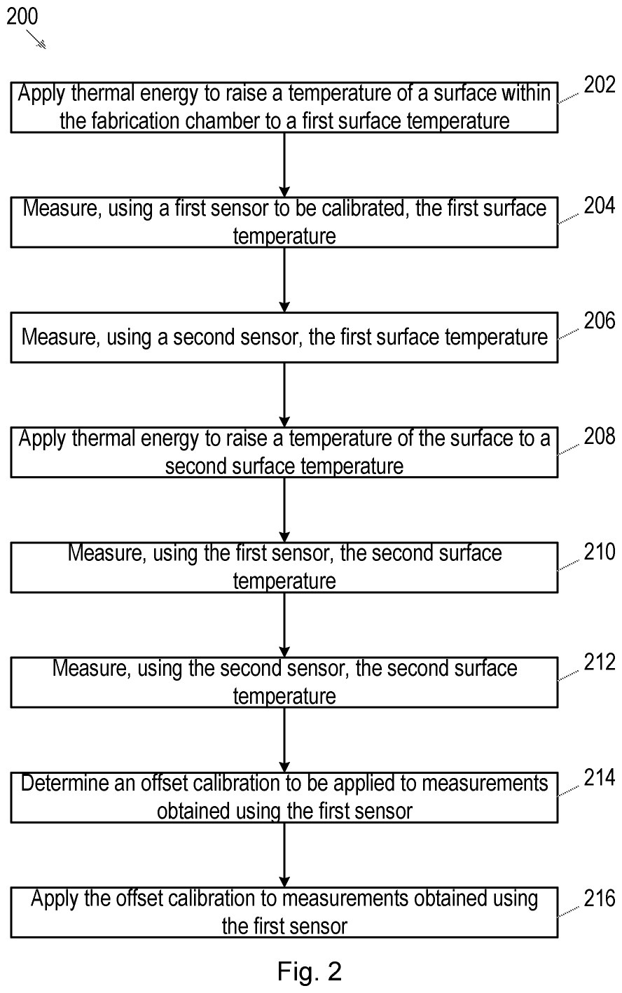

A method will now be discussed which may be used to calibrate a sensor, such as the thermal sensor 108 of FIG. 1. FIG. 2 is a flowchart of an example a method 200, such as a sensor calibration method. The method 200 comprises, at block 202, applying thermal energy to a fabrication chamber 102 of an additive manufacturing apparatus 100 to raise a temperature of a surface within the fabrication chamber to a first surface temperature. The surface may, for example, comprise a surface of a print bed forming part of, to be housed within, or functioning in conjunction with, the fabrication chamber 102. In some examples, the thermal energy may be applied to the fabrication chamber 102 using a thermal blanket in thermal communication with the fabrication chamber. For example, the thermal energy may be applied to walls of the fabrication chamber 102 and/or to the surface whose temperature is to be measured, for example using a thermal blanket. At block 204, the method 200 comprises measuring, using a first sensor 108 to be calibrated, the first surface temperature. At block 206, the method 200 comprises measuring, using a second sensor 110, the first surface temperature. Thus, the first surface temperature (i.e. the temperature of the surface to which thermal energy has been applied in block 202) is measured by both the first sensor 108 (which is to be calibrated) and the second sensor 110.

The first sensor 108 may, in some examples, comprise a sensor, such as a thermal imaging sensor, capable of acquiring a thermal image of the surface. In some examples, the first sensor may be capable of measuring a temperature of a particular point on the surface while, in other examples, it may be possible to measure temperatures at multiple positions over the surface. In some examples where multiple temperature measurements can be acquired, an average temperature may be calculated and used as the temperature measured by the first sensor 108. In other examples, the temperatures may be measured using the first sensor 108 at various locations over the surface, and each individual temperature measurement may be handled separately and used in the sensor calibration process.

The second sensor 110 may, in some examples, comprise a sensor, such as a negative temperature coefficient (NTC) thermistor, which can be positioned at a particular location (e.g. within or adjacent to the print bed 104) in order to accurately measure the temperature at that position. The second sensor 110 may, therefore, be considered to provide an accurate measurement of the temperature of the surface (e.g. the surface of the print bed 104) since many of the factors affecting the measurement acquired using the first sensor 108 do not affect the second sensor 110.

Once measurements of the first surface temperature have been acquired using the first and second sensors 108, 110, the method 200 comprises, at block 208, applying thermal energy to the fabrication chamber 102 to raise a temperature of the surface to a second surface temperature. At block 210, the method 200 comprises measuring, using the first sensor 108, the second surface temperature. At block 212, the method 200 comprises measuring, using the second sensor 110, the second surface temperature. Thus, the second surface temperature (i.e. the temperature of the surface to which thermal energy has been applied in blocks 202 and 208) is measured by both the first sensor 108 to be calibrated and the second sensor 110.

The measurements acquired using the first and second sensors 108, 110 may then be transmitted (e.g. via a wired or wireless connection) to a processor 112 for processing. A processor 112 may form part of the additive manufacturing apparatus, or may be remote from the apparatus 100. The method 200 comprises at block 214, determining, using a processor 112, based on the first and second surface temperatures measured using the first sensor 108 and on the first and second surface temperatures measured using the second sensor 110, an offset calibration to be applied to the measurements obtained using the first sensor. A simple offset calibration may be calculated by calculating a difference between the measurements acquired using the first sensor 108 and the second sensor 110 at each of the first and second surface temperatures, and taking an average. A more accurate offset calibration may be calculated using additional information, as discussed below.

Once the offset calibration has been calculated at block 214, the method 200 comprises, at block 216, applying the offset calibration to measurements obtained using the first sensor 108. Thus, once a relationship between measurements acquired using the first sensor 108 and the second sensor 110 has been determined, the offset can be applied such that subsequent measurements acquired using the first sensor 108 are more in line with (or substantially the same as) those measurements acquired using the second sensor 110.

It would, in principle, the possible to determine a relationship between the temperature measurements acquired using the first sensor 108 and the temperature measurements acquired using the second sensor 110 using just one temperature measurement acquired using the sensor. According to the present disclosure, however, each sensor is used to acquire measurements at multiple temperatures. In this way, a more accurate determination of the relationship between the first sensor measurements and the second sensor measurement can be determined. Furthermore, by obtaining measurements at multiple temperatures, additional information may be determined.

In one example, determining the offset calibration (block 214) may comprise solving the following equation:

$${T}_{sensor 2} - {T}_{offset} = \sqrt[4]{\frac{\begin{matrix}{ɛ}_{camera} \cdot {T}_{sensor 1}^{4} + ( ( 1 - {ɛ}_{camera} ) \cdot {T}_{air}^{4} ) - \\ ( ( 1 - {ɛ}_{surface} ) \cdot {T}_{sensor 2}^{4} )\end{matrix}}{{ɛ}_{surface}}} \qquad [ Eq . 1 ]$$

In equation 1 above:

Tₛₑₙₛₒᵣ₂ is the temperature measured at the surface of the fabrication chamber 102 (i.e. a surface of the print bed 104) by the second sensor 110;

T_{offset} is the offset calibration to be determined;

ε_{camera} is the emissivity of the first sensor 108 (e.g. of a material from which the sensor is made);

Tₛₑₙₛₒᵣ₁ is the temperature measured by the first sensor 108;

Tₐᵢᵣ is the air temperature adjacent to the first sensor 108; and

ε_{surface} is the emissivity of the surface (i.e. the surface of the print bed 104).

Thus, in some examples, Tₛₑₙₛₒᵣ₁ and Tₛₑₙₛₒᵣ₂ are measured by the first and second sensors 108, 110 respectively; the emissivity ε_{camera} of the first sensor (e.g. a thermal imaging camera) 108 may, for example, be provided by the sensor manufacturer; Tₐᵢᵣ may be measured using the thermometer or sensor such as an NTC to measure the temperature of the air adjacent to the first sensor 108; and an emissivity ε_{surface} of the surface may be obtained from literature, if the material from which the is made can be determined. Therefore, if ε_{camera}, Tₐᵢᵣ and ε_{surface} can be determined, and if Tₛₑₙₛₒᵣ₁ and Tₛₑₙₛₒᵣ₂ can be measured using the first sensor 108 and the second sensor 110 respectively, then a value for T_{offset} can be calculated.

As noted previously, a measurement of the air temperature near to or adjacent to the first sensor 108 may not be particularly accurate, and the emissivity of surface of the print bed 104 may not remain constant over time. Therefore, inaccuracies in these variables may lead to an inaccuracy in the determination of the temperature offset calibration. Accordingly, if measurements have been acquired using the first and second sensors 108, 110 at multiple temperatures (i.e. when the print bed has been heated up to multiple temperatures, then it is possible, using equation 1 above, to determine an additional variable or multiple additional variables. For example, it is possible to determine the air temperature within the fabrication chamber 102 adjacent to the first sensor 108, Tₐᵢᵣ, or the emissivity of the surface of the print bed 104, ε_{surface}.

In a first example, just one measurement is made by each of the first and second sensors 108, 110. The thermal energy applicator 106 is controlled to apply thermal energy to increase its temperature and, therefore, the temperature of the print bed 104, as measured by the second sensor 110 such that Tₛₑₙₛₒᵣ₂=49.85 degrees centigrade (323 Kelvin). In this example, the emissivity of the camera, ε_{camera}=0.95 and the emissivity of the surface (of the print bed 104), ε_{surface}=0.8. Using a measurement taken using a sensor (e.g. an NTC sensor) positioned adjacent to the first sensor 108 (e.g. a thermal imaging camera), it is determined that the air temperature, Tₐᵢᵣ=398 Kelvin. The first sensor 108 measures a temperature (at the print bed) of Tₛₑₙₛₒᵣ₁=290 Kelvin. Applying these values to the Equation 1, it can be determined that the offset calibration, or temperature offset, T_{offset}=31.24 Kelvin. Thus, 31.24 Kelvin is to be added to measurements recorded using the first sensor 108.

In a second example, measurements are recorded by the first and second sensors 108, 110 at two different temperatures. The thermal energy applicator 106 is controlled to apply thermal energy to increase its temperature and, therefore, the temperature of the print bed 104, as measured by the second sensor 110 such that a first measurement T_{sensor2_}1=49.85 degrees centigrade (323 Kelvin). The first sensor 108 measures a first temperature (at the print bed) of T_{sensor1_}1=290 Kelvin. Then, more thermal energy is applied to increase the temperature of the print bed such that a second measurement by the second sensor 110 T_{sensor2_}2=333 Kelvin. The first sensor 108 measures a second temperature (at the print bed) of T_{sensor1_}2=301.384 Kelvin. The emissivity of the camera, ε_{camera}=0.95 and the emissivity of the surface (of the print bed 104), ε_{surface}=0.8. Applying these values to the Equation 1, the equation can be solved using techniques that will be familiar to the skilled person, to calculate two variables: it can be determined that the offset calibration, or temperature offset, T_{offset}=31.24 Kelvin, and that the air temperature, Tₐᵢᵣ=398 Kelvin.

In some examples, a material having a defined emissivity may be positioned on the print bed 104 during the calibration process. For example, a sheet of said material may be positioned to substantially cover the print bed. In this way, the emissivity of the surface (i.e. of the material), ε_{surface} may be available, thereby removing one variable that could lead to an inaccuracy in the calculation.

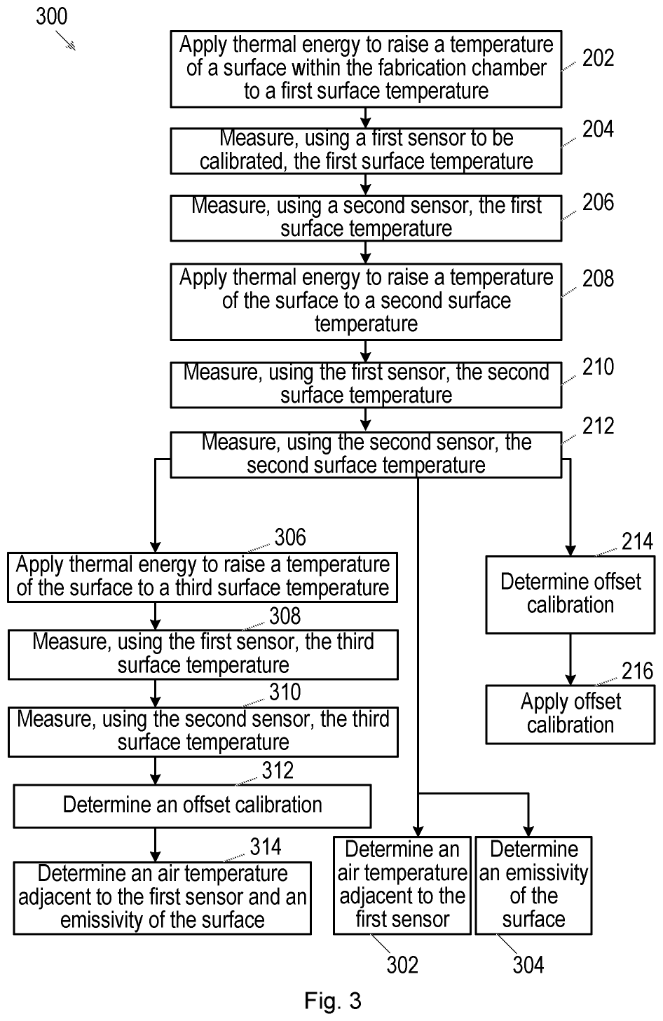

Further examples of a sensor calibration method are now described with reference to the flowchart of FIG. 3. The flowchart in FIG. 3 is an example of a method 300 which may include blocks of the method 200 discussed above. At block 302, the method 300 may comprise, determining, using a processor (e.g. the processor 112), based on the first and second surface temperatures measured using the first sensor 108, and on the first and second surface temperatures measured using the second sensor 110, an air temperature adjacent to the first sensor. Thus, the temperature is measured of the air inside the fabrication chamber 102. This may, for example, be achieved by solving Equation 1 for two variables: the offset calibration and the air temperature. It will be apparent that this can be done if measurements of the surface temperature have been recorded using the first and second sensors 108, 110 at at least two different temperatures. As noted, above, while it would be possible to measure the air temperature using a standard thermometer positioned near to the first sensor 108, such a measurement might not take into account differences in temperature through the fabrication chamber.

At block 304, the method 300 may further comprise determining, using a processor (e.g. the processor 112), based on the first and second surface temperatures measured using the first sensor 108, and on the first and second surface temperatures measured using the second sensor 110, an emissivity of the surface. This may, for example, be achieved by solving Equation 1 for two variables: the offset calibration and the surface emissivity. It will be apparent that this can be done if measurements of the surface temperature have been recorded using the first and second sensors 108, 110 at at least two different temperatures. As noted above, while it would be possible to determine the surface emissivity from literature, it is possible that other materials may form on or in the print bed, thereby changing the emissivity of the surface. By calculating the surface emissivity using Equation 1, we take account of the possibility that the emissivity of the surface may not remain constant over time.

While, in FIG. 3, the determining blocks 302, 304 are shown as alternatives to the offset determination block 214, in other examples, as noted above, the offset calibration may be determined (at block 214) as well as the air temperature (at block 302) or the surface emissivity (at block 304). In other examples, where surface temperatures are measured at three different temperatures using the first and second sensors 108, 110, it is possible to determine the offset calibration along with both the air temperature and the surface emissivity, as discussed below. Furthermore, using measurements taken at three or more different temperatures enables more robust and reliable calculations to be made of the offset calibration.

At block 306, the method 300 comprises applying thermal energy to the fabrication chamber 102 to raise a temperature of the surface to a third surface temperature. The method 300 may comprise, at block 308, measuring, using the first sensor 108, the third surface temperature. At block 310, the method 300 may comprise measuring, using the second sensor 110, the third surface temperature. Thus, the first and second sensors 108, 110 are used to measure the surface temperatures at each of three different temperatures once the fabrication chamber (and therefore the surface) has been heated to three different target temperatures (e.g. using a thermal energy applicator 106, such as a thermal blanket). The method 300 may comprise, at block 312, determining an offset calibration based on the first, second and third surface temperatures measured using the first sensor 108 and based on the first, second and third surface temperatures measured using the second sensor 110. By determining the offset calibration using measurements taken at three different surface temperatures, the determined offset calibration is likely to be more robust. In some examples, an offset calibration may be determined for each surface temperature, and an average of the three values may be calculated. In other examples, measurements may be taken at more than three surface temperatures, thereby providing an even more robust offset calibration.

At block 314, the method 300 may further comprise determining, using a processor, based on the first, second and third surface temperatures measured using the first sensor 108, and on the first, second and third surface temperatures measured using the second sensor 110, an air temperature of air adjacent to the first sensor and an emissivity of the surface. Thus, as noted above, when measurements are taken at three different surface temperatures, it is possible to determine three variables in Equation 1, for example, the offset calibration, the air temperature and the surface emissivity.

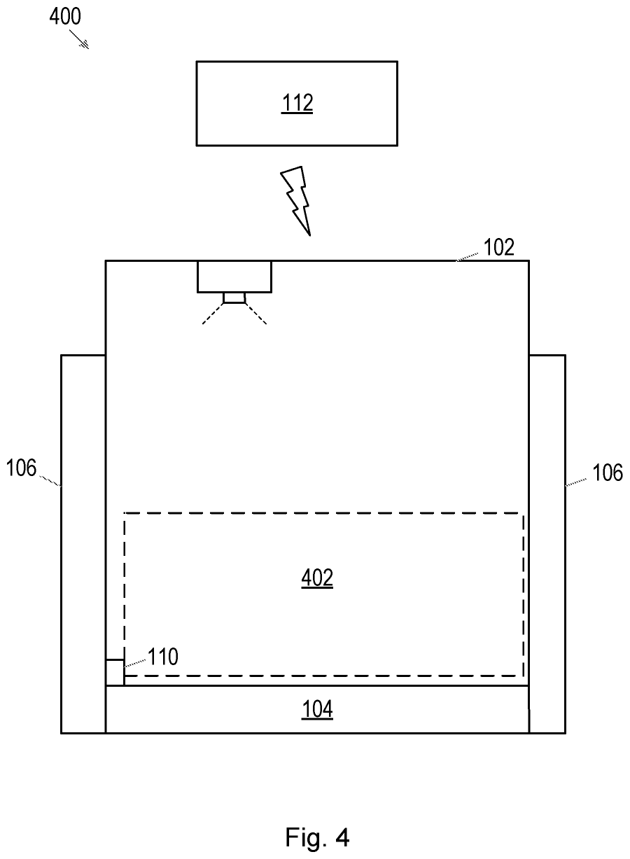

FIG. 4 is a schematic illustration of an example of an apparatus 400. The apparatus 400 may comprise an additive manufacturing apparatus. The apparatus 400 may be considered to be an example of a particular implementation of the apparatus 100 described above and, as such, like reference numerals are used for like features.

The apparatus 400 includes the fabrication chamber 102. The print bed 104 is positioned within, or towards the bottom of the fabrication chamber 102, on which a three-dimensional object may be formed by processing successive layers of build material. The object may, for example, be formed within the region indicated by the hatched region 402. The thermal energy applicator 106, which may comprise a thermal blanket is, in this example, formed in or around walls of the fabrication chamber 102, so as to provide thermal energy (i.e. heat) to the fabrication chamber (e.g. to the walls of the fabrication chamber and to the print bed 104.

The first thermal sensor 108 is, in this example, located towards the top of the fabrication chamber, such that the first thermal sensor is able to measure a temperature or temperatures of at least part of the print bed 104. In some examples, the first thermal sensor 108 may comprise a thermal imaging sensor, capable of producing data to form a thermal image or thermal map of a surface (e.g. a surface of the print bed 104), showing temperature variations across the surface. Dashed lines in FIG. 4 indicate an example field of view of the first thermal sensor. In one example, the first thermal sensor 108 may comprise a sensor provided by Heimann Sensor GmbH. The first thermal sensor 108 may, in some examples, be mounted to a carriage, which may also house an agent distributor and/or a build material distributor, such that the first thermal sensor is moveable relative to the print bed 104. In other examples, the first thermal sensor 108 may be mounted to a top cover or a roof of the fabrication chamber 102, and may not be moveable relative to the print bed 104.

The second thermal sensor 110 is positioned so as to measure a temperature of the thermal energy applicator 106 (e.g. the print blanket) at or adjacent to the print bed 104. Thus, the thermal energy applicator 106 may be located adjacent to the print bed 104 so that heat can be transferred effectively to the print bed. In some examples, the thermal energy applicator 106 may extend through or under the print bed 104 for more effective heat transfer. In the example shown, just one second thermal sensor 110 is shown; in other examples, an average may be calculated of multiple thermal sensors provided at or near to the print bed and/or the thermal blanket. As noted above, the second thermal sensor 110 may, in some examples, comprise a negative temperature coefficient (NTC) sensor while, in other examples, another type of sensor capable of measuring temperature may be used.

The processor 112 is shown, in this example, as a remote processor, capable of communicating with components of the apparatus 400, for example using wireless communication protocols. In other examples, the processor 112 may form part of the apparatus 400. The processor 112 may receive data (e.g. measurements) from the first and second thermal sensors 108, 110 for processing. In some examples, the processor may control components of the apparatus 400, such as the thermal energy applicator 106 and/or the thermal sensors 108, 110. As already discussed, the processor 112 is to determine, based on the target temperatures measured by the first and second thermal sensors 108, 110, a correction (e.g. a thermal offset, or offset calibration) to be applied to measurements acquired using the first thermal sensor. The processor 112 may then apply the determined correction to subsequent measurements acquired using the first thermal sensor 108. In some examples, the processor 112 may determine, based on the target temperatures measured by the first and second thermal sensors 108, 110, an ambient temperature (e.g. a temperature of the air near to or adjacent to the first sensor 108) within the fabrication chamber 102 and/or an emissivity of the print bed 104 (e.g. a surface of the print bed). In some examples, the variables (e.g. the correction, the ambient temperature and/or the print bed emissivity) may be determined using Equation 1 discussed above.

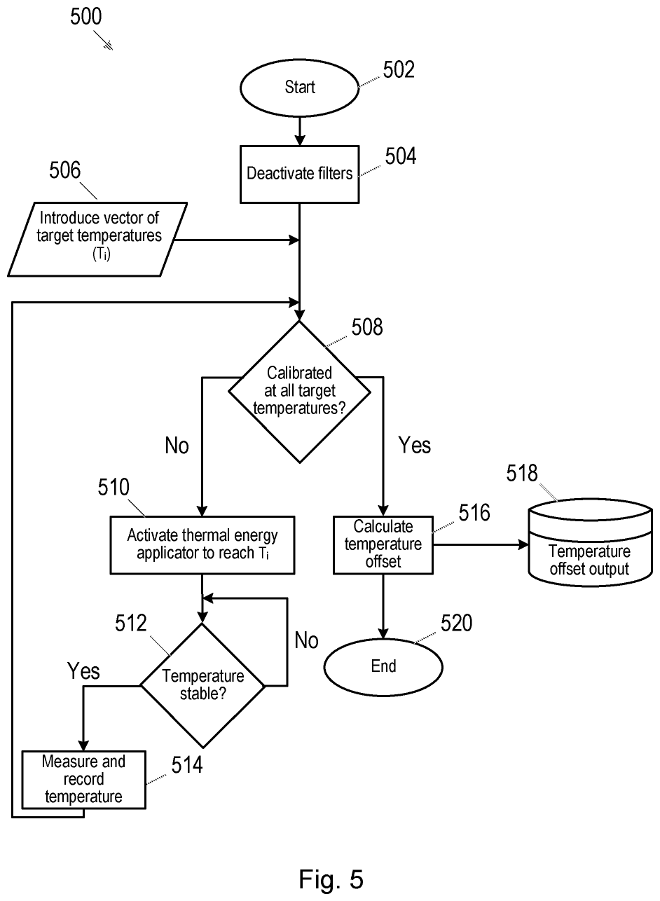

The calibration of the first sensor 108 may be performed automatically, for example by the processor 112 upon instruction from a user (e.g. an operator). FIG. 5 is a flowchart of an example of a sensor calibration method or process 500 that may be performed to calibrate a sensor, such as the first sensor 108. The calibration process starts at block 502. At block 504, any previous calibrations or adjustments that may have been applied to the first sensor 108 are removed. For example, an offset applied to the first sensor 108 as a result of a previous calibration may be removed or cancelled. A vector of target temperatures is introduced in block 506. The target temperatures are the temperatures to which the fabrication chamber 102 and/or the print bed 104 are to be heated by the thermal energy applicator (e.g. the thermal blanket) 106. Such a vector may, for example, comprise a series of two, three or more temperatures (e.g. 40 degrees, 50 degrees and 60 degrees). The target temperatures may be chosen based on the intended use of the fabrication chamber (e.g. based on the build material to be used, or the temperatures to be used during the build process).

At block 508, a check is made to determine whether or not all of the target temperatures in the vector have been calibrated. If the output at block 508 is ‘no’, then the thermal energy applicator 106 (e.g. the thermal blanket) is activated at block 510, so that its temperature is raised to the next target temperature in the vector. When heat is applied to the fabrication chamber 102 by the thermal energy applicator 106, the temperature measured by the second thermal sensor 110 may increase more slowly than the thermal energy applicator reaches its target temperature. Therefore, at block 512, the method 500 checks whether the temperature measured by the second thermal sensor 110 is stable. If the output at block 512 is ‘no’, a further check for stability may be performed after a defined period of time has elapsed. Once it is determined that the temperature measured by the second thermal sensor 110 is stable, a temperature is measured at block 514 using the first thermal sensor 108 (e.g. a Heimann thermal sensor) and this value is recorded (e.g. in a memory). The process returns to block 508, where a further check is performed to check whether measurements are to be recorded at any more temperatures in the vector. The above process from blocks 508 to 514 is repeated for all of the target temperatures provided in the vector. Once the measurements have been taken for all of the target temperatures, the method 500 progresses to block 516, where the measurements made using the first thermal sensor 108 and the second thermal sensor 110 at all of the target temperatures are used to solve determine the temperature offset. For example, the measurements may be used to solve Equation 1 above, in order to determine a temperature offset. The determined temperature offset is output at block 518, and may be stored and/or applied to subsequent measurements made using the first thermal sensor 108. The calibration method 500 ends at block 520.

The calibration (e.g. the methods 200, 300, 500) may be performed prior to an additive manufacturing operation being performed using the apparatus. In some examples, the first thermal sensor 108 may be calibrated once the apparatus has been manufactured or installed.

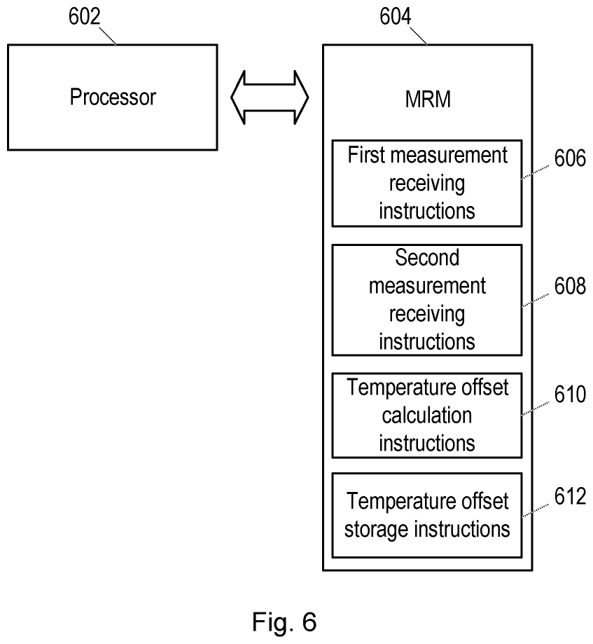

The present disclosure also provides a machine-readable medium. FIG. 6 is a schematic illustration of a machine-readable medium 604 and a processor 602. The processor 602 may comprise the processor 112. The machine-readable medium 604 comprises instructions (e.g. first measurement receiving instructions 606) which, when executed by the processor 602, cause the processor to receive a first plurality of surface temperature measurements of a surface of a build chamber (e.g. the fabrication chamber 102) of an additive manufacturing apparatus 100, on which surface three-dimensional objects can be built on a layer-by-layer basis using successively processed layers of build material, wherein each of the first plurality of surface temperature measurements is acquired using a first sensor 108 after a temperature of the surface has been varied by a defined amount. The temperature of the surface may be varied in some examples by applying heat/thermal energy using the thermal energy applicator 106, such as a thermal blanket. The machine-readable medium 604 comprises instructions (e.g. second measurement receiving instructions 608) which, when executed by the processor 602, cause the processor to receive a second plurality of surface temperature measurements of the surface, wherein each of the second plurality of surface temperature measurements is acquired using a second sensor 110 concurrently with the first plurality of surface temperature measurements. In other words, measurements are taken by both the first sensor 108 and the second senor 110 at each target temperatures reached after the temperature of the surface has been varied by a defined amount.

The machine-readable medium 604 comprises instructions (e.g. temperature offset calculation instructions 610) which, when executed by the processor 602, cause the processor to calculate, based on the first plurality of surface temperature measurements and the second plurality of surface temperature measurements, a temperature offset relating the first plurality of surface temperature measurements to the second plurality of surface temperature measurements. The machine-readable medium 604 comprises instructions (e.g. temperature offset storage instructions 612) which, when executed by the processor 602, cause the processor to store the calculated temperature offset to be applied to subsequent surface temperature measurements of the surface acquired using the first sensor 108. The temperature offset may be stored in a storage medium, such a memory, in communication and accessible by the processor 112, 602.

In some examples, the machine-readable medium 604 may comprises instructions (e.g. air temperature calculation instructions) which, when executed by the processor 602, cause the processor to calculate, based on the first and second plurality of surface temperature measurements, a temperature of air inside the build chamber after a temperature of the surface has been varied by the defined amount. The machine-readable medium 604 may comprises instructions (e.g. surface emissivity calculation instructions) which, when executed by the processor 602, cause the processor to calculate, based on the first and second plurality of surface temperature measurements, an emissivity of the surface within the build chamber (e.g. a surface of the print bed 104).

Example of the present disclosure provide a mechanism by which a robust and accurate relationship between temperatures measured by two different thermal sensors may be determined, such that one of the sensors can be calibrated. The disclosure also enables other variables to be determined in a manner that is more robust that simply measuring them (e.g. air temperature) or determining their values from literature (e.g. surface emissivity).

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A sensor calibration method, comprising:
applying thermal energy to a fabrication chamber of an additive manufacturing apparatus to raise a temperature of a surface within the fabrication chamber to a first surface temperature;
measuring, using a first sensor to be calibrated, the first surface temperature;
measuring, using a second sensor, the first surface temperature;
applying thermal energy to the fabrication chamber to raise a temperature of the surface to a second surface temperature;
measuring, using the first sensor, the second surface temperature;
measuring, using the second sensor, the second surface temperature;
determining, using a processor, based on the first and second surface temperatures measured using the first sensor and on the first and second surface temperatures measured using the second sensor, an offset calibration to be applied to measurements obtained using the first sensor; and
applying the offset calibration to measurements obtained using the first sensor.

2. A method according to claim 1, further comprising:
determining, using a processor, based on the first and second surface temperatures measured using the first sensor, and on the first and second surface temperatures measured using the second sensor, an air temperature adjacent to the first sensor.

3. A method according to claim 1, further comprising:
determining, using a processor, based on the first and second surface temperatures measured using the first sensor, and on the first and second surface temperatures measured using the second sensor, an emissivity of the surface.

4. A method according to claim 1, further comprising:
applying thermal energy to the fabrication chamber to raise a temperature of the surface to a third surface temperature;
measuring, using the first sensor, the third surface temperature; and
measuring, using the second sensor, the third surface temperature;
wherein said determining comprises determining an offset calibration based on the first, second and third surface temperatures measured using the first sensor and based on the first, second and third surface temperatures measured using the second sensor.

5. A method according to claim 4, further comprising:
determining, using a processor, based on the first, second third surface temperatures measured using the first sensor, and on the first, second and third surface temperatures measured using the second sensor, an air temperature adjacent to the first sensor and an emissivity of the surface.

6. A method according to claim 1, wherein said determining comprises solving the following equation:
$${T}_{sensor 2} - {T}_{offset} = \sqrt[4]{\frac{\begin{matrix}{ɛ}_{camera} \cdot {T}_{sensor 1}^{4} + ( ( 1 - {ɛ}_{camera} ) \cdot {T}_{air}^{4} ) - \\ ( ( 1 - {ɛ}_{surface} ) \cdot {T}_{sensor 2}^{4} )\end{matrix}}{{ɛ}_{surface}}}$$
where:
Tₛₑₙₛₒᵣ₂ is the temperature measured at the surface of the fabrication chamber by the second sensor;
T_{offset} is the offset calibration to be determined;
ε_{camera} is the emissivity of the first sensor;
Tₛₑₙₛₒᵣ₁ is the temperature measured by the first sensor;
Tₐᵢᵣ is the air temperature adjacent to the first sensor; and
ε_{surface} is the emissivity of the surface.

7. A method according to claim 1, wherein the first sensor comprises a thermal camera.

8. A method according to claim 1, wherein the second sensor comprises a negative temperature coefficient sensor.

9. A method according to claim 1, wherein the thermal energy is applied to the fabrication chamber using a thermal blanket in thermal communication with the fabrication chamber.

10. An additive manufacturing apparatus comprising:
a fabrication chamber to house a print bed on which a three-dimensional object may be formed by processing successive layers of build material;
a thermal energy applicator to apply thermal energy to the fabrication chamber to successively heat up the print bed to at least two different target temperatures;
a first thermal sensor to be calibrated, the first thermal sensor to measure the target temperatures of the print bed;
a second thermal sensor to measure the target temperatures of the print bed;
a processor to:
determine, based on the target temperatures measured by the first and second thermal sensors, a correction to be applied to measurements acquired using the first thermal sensor; and
apply the determined correction to subsequent measurements acquired using the first thermal sensor.

11. An apparatus according to claim 10, wherein the first thermal sensor comprises a thermal imaging camera, and the second thermal sensor comprises a negative temperature coefficient sensor.

12. An apparatus according to claim 10, wherein the processor is to:
determine, based on the target temperatures measured by the first and second thermal sensors, an ambient temperature within the fabrication chamber and/or an emissivity of the print bed.

13. A machine-readable medium comprising instructions which, when executed by a processor, cause the processor to:
receive a first plurality of surface temperature measurements of a surface of a build chamber of an additive manufacturing apparatus, on which surface three-dimensional objects can be built on a layer-by-layer basis using successively processed layers of build material, wherein each of the first plurality of surface temperature measurements is acquired using a first sensor after a temperature of the surface has been varied by a defined amount;
receive a second plurality of surface temperature measurements of the surface, wherein each of the second plurality of surface temperature measurements is acquired using a second sensor concurrently with the first plurality of surface temperature measurements;
calculate, based on the first plurality of surface temperature measurements and the second plurality of surface temperature measurements, a temperature offset relating the first plurality of surface temperature measurements to the second plurality of surface temperature measurements; and
store the calculated temperature offset to be applied to subsequent surface temperature measurements of the surface acquired using the first sensor.

14. A machine-readable medium according to claim 13, further comprising instructions which, when executed by a processor, cause the processor to:
calculate, based on the first and second plurality of surface temperature measurements, a temperature of air inside the build chamber after a temperature of the surface has been varied by the defined amount.

15. A machine-readable medium according to claim 13, further comprising instructions which, when executed by a processor, cause the processor to:
calculate, based on the first and second plurality of surface temperature measurements, an emissivity of the surface within the build chamber.
